(19) United States
(12) Patent Application Publication
(10) Pub. No.: US 2006/0225582 A1
(43) Pub. Date: Oct. 12, 2006

(54) Apparatus and method for orienting rotatable objects

(76) Inventors: Uri Tasch, Baltimore, MD (US); Priya Narayanan, Baltimore, MD (US); Alan Lefcourt, Elkridge, MD (US); Moon Sung Kim, Silver Spring, MD (US); Abraham Grinblat, Haifa (IL)

Correspondence Address: JENKENS & GILCHRIST, P.C., 225 WEST WASHINGTON, SUITE 2600, CHICAGO, IL, 60606, US

(21) Appl. No.: 11/447,833

(22) Filed: Jun. 6, 2006

Related U.S. Application Data
(63) Continuation of application No. 11/283,384, filed on Nov. 18, 2005.
(60) Provisional application No. 60/629,779, filed on Nov. 19, 2004.
(60) Provisional application No. 60/695,504, filed on Jun. 30, 2005.

(51) Int. Cl. A23G 1/10

(52) U.S. Cl. 99/485

(57) ABSTRACT

An apparatus for orienting an object about its stable spinning axis includes a support having a support surface, the support surface being inclined relative to the horizontal. In this apparatus, the length and the inclination of the support surface is selected to, in combination, impart a minimum critical rotational velocity to an object rolled on the support surface. The minimum critical rotational velocity is sufficient to at least substantially align the rotation of the object about its stable spinning axis.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE DISCLOSURE

The present disclosure relates generally to an apparatus and method for orienting rotatable objects and, more particularly, to an apparatus and method for orienting fruits such as, but not limited to, apples during processing.

### BACKGROUND

The food industry, more specifically that portion relating to the harvest, packaging, transport, storage, and sale of fresh fruits and vegetables, is a multibillion-dollar industry internationally. Enhancements to technologies for determining the quality and of food products, such as fruits and vegetables, can increase profitability by, for example, ensuring that only saleable products are passed to a subsequent component of the food distribution chain, thereby minimizing waste. The quality of the food products is of great importance in the business of modern agriculture.

Apples, as one example, represent a US business valued at more than $1.8 billion dollars annually, which places it as the third most valuable fruit crop in the United States following grapes and oranges. Of this crop, roughly 59 percent of apple production is marketed as fresh fruit destined for retail sale. In 2003, 5.34 billion pounds of fresh apples were produced at a value of about $1.58 billion and the United States exported 1.16 billion pounds of fresh apples for about $347 million. Once harvested, apples are routed through numerous stages of mechanical and manual treatment, transport, storage, inspection and/or packaging. Damage to apples including bruises, scratches, scrapes, and holes may occur in any of these, or other, stages. In addition fecal contamination that leads to e-coli contamination is a major health hazard that can be found in apples. These types of contamination and/or damage impair the fruit quality and marketability and likewise reduce profits.

To minimize losses associated with packing and transport of unmarketable product, such as fruits and vegetables, inspections are performed prior to packaging to ascertain the condition and quality of the product to ensure appropriate characterization and classification of the product. In apple processing, for example, non-destructive techniques are used to detect surface and sub-surface damage (e.g., bruises) and/or characteristics (e.g., firmness).

The aforementioned inspection techniques require, however, positioning of the apples in a specific orientation (e.g., a horizontal orientation of the stem-calyx axis) to not mistakenly confuse the stem or calyx for a bruise and to permit the non-destructive sensors to operate effectively. Existing commercial equipment used to orient fruit for inspection and/or packaging is shown, for example, in U.S. Pat. No. 5,855,270 to Throop et al., U.S. Pat. No. 5,190,137 to Tas, and U.S. Pat. No. 4,169,528 to Amstad. As noted in U.S. Pat. No. 5,855,270 to Throop et al., many known techniques for orienting apples so that their stem-calyx axes are horizontal do not reliably orient the apples or do not adequately maintain such orientation once achieved.

Another commercial fruit-orienting device dubbed as “Apfelrobo” was recently introduced by Hoerbiger-Origa of Filderstadt, Germany, to orient apples in an apple packaging system. In the Apfelrobo device, apples are delivered on a conveyor, individually picked up by a suction cup on a belt-driven actuator, and rotated by an impinging air stream until the stem is vertically upright.

However, despite these improvements in the commercial equipment used to position fruits for inspection, these devices are nonetheless complex, with many moving parts, less reliable, and quite expensive.

Another non-destructive technique was developed to employ machine-vision and algorithms to distinguish the stem and calyx regions of the apples from the remainder of the apple to avoid the need for positioning of the apples in a particular orientation and to avoid the need for the corresponding apple positioning equipment. However, such techniques have thus far been unable to provide the throughput capability required in commercial apple sorting processes and are still an area of current research.

Accordingly, a need exists for a reliable, inexpensive and/or simple device or method for orienting rotatable objects such as, but not limited to, fruits and vegetables, to an orientation conducive to a subsequent inspection and/or processing step.

### SUMMARY

Herein provided are descriptions of various novel apparatuses and methods for orienting rotatable objects. The concepts herein relate, in part, to apparatuses and methods for orienting a rotatable object by minimizing the action of a rotatable object or, stated differently, by imparting a sufficient rotational velocity so that the rotatable object reorients itself to spin stably about the axis which is perpendicular to the plane formed by the two other axes with equal or generally or substantially equal moments of inertia In other words, the stable spinning axis is along the distinct moment of inertia which is either maximum or minimum in value.

According to one aspect of the present concepts, an apparatus for orienting an object about its stable spinning axis includes a support having a support surface, the support surface being inclined relative to the horizontal. In this apparatus, the length and the inclination of the support surface is selected to, in combination, impart a minimum critical rotational velocity to an object rolled on the support surface. The minimum critical rotational velocity is sufficient to at least substantially align the rotation of the object about its stable spinning axis.

According to another aspect of the present concepts, there is provided an apparatus for orienting an object about stable spinning axis. This apparatus includes a support having spaced-apart support surfaces, each of the support surfaces including a belt movable in a first direction at a predetermined minimum velocity being selected to impart to an object placed thereupon a minimum critical rotational velocity. This minimum critical rotational velocity is sufficient to at least substantially align the rotation of the object about its stable spinning axis. A restraint is also provided to impede translation of the object in the first direction.

In yet another aspect of the present concepts, an apparatus for orienting an apple about its stable spinning axis includes a support having at least one support surface inclined at an angle greater than the dynamic friction factor between the support surface and an apple to be conveyed thereupon over at least a portion thereof. The length of the support surface and the inclination of the support surface is selected to, in combination, impart a minimum critical rotational velocity to an apple rolled down the support surface. The minimum critical rotational velocity is sufficient to at least substantially align the rotation of the apple about its stable spinning axis.

According to yet another aspect of the present concepts, a method for orienting an object about its stable spinning axis includes the acts of disposing the object on a support having at least one support surface and increasing the rotational velocity of the object at least until the objects' axis having the maximum or minimum yet distinct moment of inertia is aligned substantially perpendicular to a direction of travel along the support.

Still yet another aspect of the present concepts includes a method for orienting an object about its stable spinning axis including the acts of orienting a support having a support surface at an incline relative to the horizontal, the inclination of the support surface being sufficient to impart a minimum critical rotational velocity to an object rolled along a length of the support surfaces. The minimum critical rotational velocity is sufficient to at least substantially align the rotation of the object about its stable spinning axis. The method also includes the act of rolling an object down the support surface to at least substantially align the rotation of the object about its stable spinning axis.

These and additional aspects of the present concepts will be apparent to those of ordinary skill in the art in view of the detailed description of various non-limiting examples and embodiments and exemplary drawings, which follow.

### BRIEF DESCRIPTION OF THE DRAWINGS

FIGS. 1(a)-(b) depict the dynamic characteristic of a generalized rotatable object rolling about an axis of rotation in a stable and unstable orientation, respectively, in accord with the present concepts.

FIGS. 2(a)-(b) show examples of apparatuses in accord with the present concepts configured to orient a rotatable object from an unstable spinning axis to a stable spinning axis.

FIGS. 3(a)-(b) show acts in methods of orienting a rotatable object about its stable spinning axis in accord with the present concepts.

### DETAILED DESCRIPTION

While the concepts disclosed herein are susceptible of embodiment in many different forms, there is shown in the drawings and will herein be described in detail preferred embodiments of the present concepts with the understanding that the present disclosure is to be considered as an exemplification of the principles of the present concepts and is not intended to limit the broad aspects thereof to the illustrated embodiments.

The axis about which a rotatable object rotates is determined by the Maupertuis principle of least action, later refined by Hamilton and Lagrange. The principle of least action states that “of all the possible paths along which a dynamical system may move from one point to another within a specified time interval, the actual path followed is that which minimizes the action.” The action, S, is defined as:

$$S = {\int }_{{t}_{1}}^{{t}_{2}} L ⅆ t \qquad ( 1 )$$

where L is the Lagrangian, which is defined as L=T−V, where T is the kinetic energy and V the potential energy. In accord with this principle, the object will rotate at steady state about the axis that minimizes the quantity S, the “action.” As well known, Lagrangian mechanics are easily derivable from Newton's equations of motion and provide an alternative approach to Newtonian mechanics which yield, for the same dynamic system, equivalent equations of motion. Lagrangian mechanics thus permit solution of problems using different quantities and constraints, which simplifies analysis in some types of problems such as, but not limited to, problems in calculus of variations and optimization. From the Lagrangian, other equations of motion can be likewise be derived in accord with known principles and manipulations, such as Euler's equations. Euler's equations are tested for stability in accord with aspects of the present concepts in the following sections.

By way of introduction, the stability of rotational motion of a rotatable object about a principal axis may be represented by Euler's equations for rotational motion in principal axes frame xyz, given by:

$$\begin{matrix}{M}_{x} = {I}_{xx} \frac{ⅆ {ω}_{x}}{ⅆ t} + ( {I}_{zz} - {I}_{yy} ) {ω}_{y} {ω}_{z} & ( 2 ) \\ {M}_{y} = {I}_{yy} \frac{ⅆ {ω}_{y}}{ⅆ t} + ( {I}_{xx} - {I}_{zz} ) {ω}_{x} {ω}_{z} & ( 3 ) \\ {M}_{z} = {I}_{zz} \frac{ⅆ {ω}_{z}}{ⅆ t} + ( {I}_{yy} - {I}_{xx} ) {ω}_{x} {ω}_{y} & ( 4 )\end{matrix}$$

where ω is the rotational or angular velocity and M is the applied moment.

In the examples which follow, an apple will be used to demonstrate one application and concrete example of an implementation of the present concepts. The present concepts are not limited thereby and may be applied to any apparatus and method for orienting any rotatable objects (e.g., a food item, such as a fruit or vegetable, or a non-food item) which may be rolled about a first, second, and third axes, particularly those objects possessing a moment of inertia along a first axis that is different than the moments of inertia along the second and third axes, which are equal or generally or substantially equal in value. The present concepts apply generally to rotatable objects which require a preferred orientation for a processing step, such as inspection, sorting, movement, and packaging.

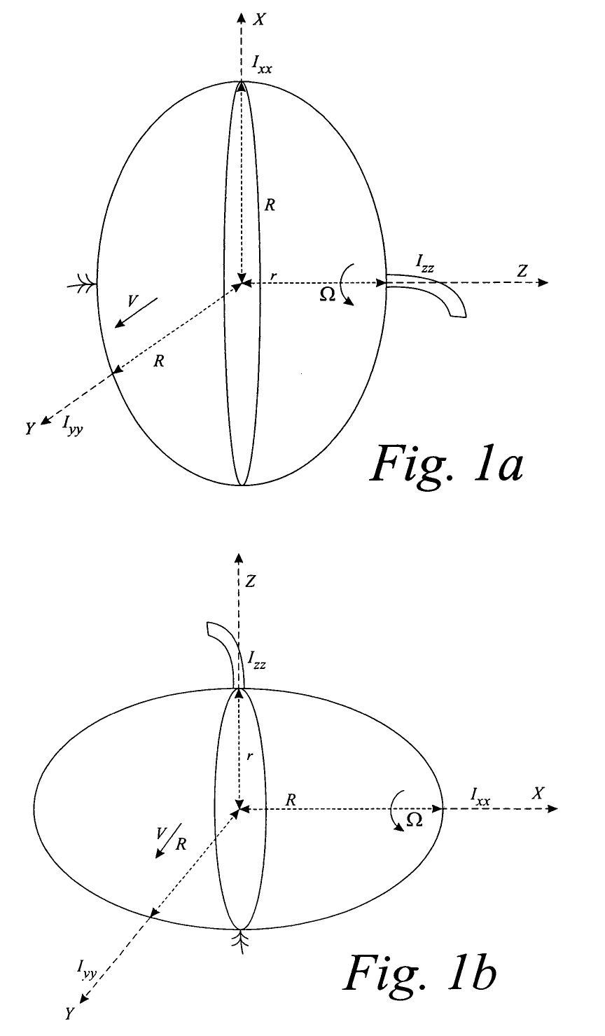

Assuming initially that the rotatable object, an apple in this example, is ellipsoidal with equal radii R in the x and y directions and a radius r in the z direction, such as shown in FIGS. 1(a) and 1(b). Symmetry of the apple along the z axis yields Iₓₓ=I_{yy}≢I_{zz}.

Euler's equations (Eq. (2)-(4)) are analyzed for stability via linear control theory and as such with no lose of generality one can set the moments (system inputs) to zero. Equations (2)-(4) are reduced to:

$$\begin{matrix}{I}_{xx} \frac{ⅆ {ω}_{x}}{ⅆ t} + ( {I}_{zz} - {I}_{xx} ) {ω}_{y} {ω}_{z} = 0 & ( 5 ) \\ {I}_{xx} \frac{ⅆ {ω}_{y}}{ⅆ t} + ( {I}_{xx} - {I}_{zz} ) {ω}_{x} {ω}_{z} = 0 & ( 6 ) \\ {I}_{zz} = \frac{ⅆ {ω}_{z}}{ⅆ t} = 0 & ( 7 )\end{matrix}$$

In a first example, wherein the exemplary apple is rotated with a constant velocity Ω about the Z axis, as shown in FIG. 1(a), the angular velocities components about each of the axes may respectively be written as ω_{z}=Ω+δω_{z}·ωₓ=δωₓ and ω_{y}=δω_{y}. Hence, for the depicted ellipsoid rolling on the minor axis, dω_{z}/dt=0 (from equation 7) and ω_{z} must therefore be a constant, which may be represented by:
ω_{z}=Ω (8)

Differentiation of equations (5) yields:

$${I}_{xx} \frac{{ⅆ}^{2} {ω}_{x}}{ⅆ {t}^{2}} + ( {I}_{zz} - {I}_{xx} ) Ω \frac{ⅆ {ω}_{y}}{ⅆ t} = 0 \qquad ( 9 )$$

Equation (6) can be written as:

$$\frac{ⅆ {ω}_{y}}{ⅆ t} = \frac{( {I}_{zz} - {I}_{xx} )}{{I}_{xx}} {ω}_{x} Ω \qquad ( 10 )$$

and substitution of equation (10) into equation (9) further yields

$$\frac{{ⅆ}^{2} {ω}_{x}}{ⅆ {t}^{2}} + \frac{{( {I}_{zz} - {I}_{xx} )}^{2}}{{I}_{xx}^{2}} {Ω}^{2} {ω}_{x} = 0 \qquad ( 11 )$$

Equation (11) is stable since

$$\frac{{( {I}_{zz} - {I}_{xx} )}^{2}}{{I}_{xx}^{2}} {Ω}^{2} > 0 \qquad ( 12 )$$

Assuming next that the ellipsoid representing, by way of example, an apple is rotated about the (major) X-axis with an angular velocity Ω, as shown in FIG. 1(b), the angular velocity components about the defined axes may respectively be written as, ωₓ=Ω+δωₓ·ω_{y}=δω_{y} and ω_{z}=δω_{z}. By linearizing equation (5) we obtain dωₓ/dt=0, and it follows that ωₓ must therefore be a constant and may be represented by ωₓ=const=Ω.

Differentiating equation (6) yields:

$${I}_{xx} \frac{{ⅆ}^{2} {ω}_{y}}{ⅆ {t}^{2}} + ( {I}_{xx} - {I}_{zz} ) Ω \frac{ⅆ {ω}_{z}}{ⅆ t} = 0 \qquad ( 13 )$$

and substitution of dω_{z}/dt from equation (7) yields d²ω_{y}/dt²=0 or ω_{y}=At+B. It can be seen then that □_{y} grows linearly with time and that rotation about the x or y axes are not stable modes of rotation. Thus, under this ellipsoidal model, an apple that rolls about any axis other than the Z-axis, as illustrated in FIG. 1(b), will change its orientation to reach the stable mode of rotation. In this particular example, the stable mode of rotation is rotation about the Z-axis, which is the stable spinning axis in this case. The theoretical minimum angular velocity required for orienting a rotatable object is:

$${ω}_{min} = \sqrt{\frac{2 m g ( R - r ) {I}_{xx}}{{I}_{zz} ( {I}_{zz} - {I}_{xx} )}} \qquad ( 14 )$$

where m is the mass of the rotatable object g is gravitational acceleration.

As a verification of the aforementioned concepts, as applied to the experimental object of an apple, a tilted elliptic spindle torus was used as a model. The parametric equation of a tilted elliptic torus can be written as:
x=(c+a cos T cos u−b sin T sin u)cos v (15a)
y=(c+a cos T cos u−b sin T sin u)sin v (15b)
z=(0+a sin T cos u+b cos T sin u) (15c)
where T is the tilt angle of the ellipse and u, υε[0,2π]. Introducing a non-dimensional parameter σ provides:
x=(c+σa cos T cos u−σb sin T sin u)cos σ (16a)
y=(c+σa cos T cos u−σb sin T sin u)sin σ (16b)
z=(0+σa sin T cos u+σb cos T sin u) (16c)

If it is assumed that the self intersecting region of the tilted elliptic spindle torus is hollow, which may be reasonably assumed for the present example of an apple, the moment of inertia is.

$$\begin{matrix}I = [ \begin{matrix}{I}_{xx} & 0 & 0 \\ 0 & {I}_{yy} & 0 \\ 0 & 0 & {I}_{zz}\end{matrix} ] \\ where & ( 17 ) \\ \begin{matrix}{I}_{xx} = {I}_{yy} \\ = \frac{1}{4} ρ abc {π}^{2} ( {a}^{2} {cos}^{2} ( T ) + 3 {b}^{2} - {b}^{2} {cos}^{2} ( T ) + 2 {a}^{2} + 4 {c}^{2} )\end{matrix} & ( 18 a ) \\ {I}_{zz} = \frac{1}{2} ρ abc {π}^{2} ( 3 {a}^{2} {cos}^{2} ( T ) + 3 {b}^{2} - 3 {b}^{2} {cos}^{2} ( T ) + 4 {c}^{2} ) & ( 18 b )\end{matrix}$$

With respect to equation (17), it may be assumed that these products of inertia may be presumed to have minimal impact for tilt angles T less than about X.

The moment of inertia, inclusive of the products of inertia, may also be numerically calculated through integration as follows.

$$I = {\int }_{v} ρ ( x , y , z ) \frac{J + \vert J \vert}{2} [ \begin{matrix}{y}^{2} + {z}^{2} & - xy & - xz \\ - xy & {z}^{2} + {x}^{2} & - yz \\ - xz & - yz & {x}^{2} + {y}^{2}\end{matrix} ] ⅆ u ⅆ v ⅆ σ \qquad ( 19 )$$

where ρ(x, y, z) is the density of the tilted elliptic spindle torus and J is defined as:
J=σab[c+σa cos T cos u−σb sin T sin u}] (20)

These equations are presented only as a current theoretical base and are intended merely to provide a reasoned explanation for the dynamics underlying the apparatus and method of the present concepts. The equations are not intended to be limiting or absolute in any respect and do not necessarily reflect a complete explanation of or understanding of, the underlying physics behind the observed phenomena, set forth and further described below.

In accord with the preceding discussion, a method and apparatus for orienting rotatable objects is discussed below. As noted above, in one aspect, the present disclosure applies to orienting rotatable objects possessing a moment of inertia along a first axis that is distinct (i.e., greater or smaller) from a moment of inertia along the second and third axes, which are generally equal in the example on an apple. In the preceding example of an apple, which example is continued below for continuity, various embodiments of the apparatus and method for orienting the apple are described.

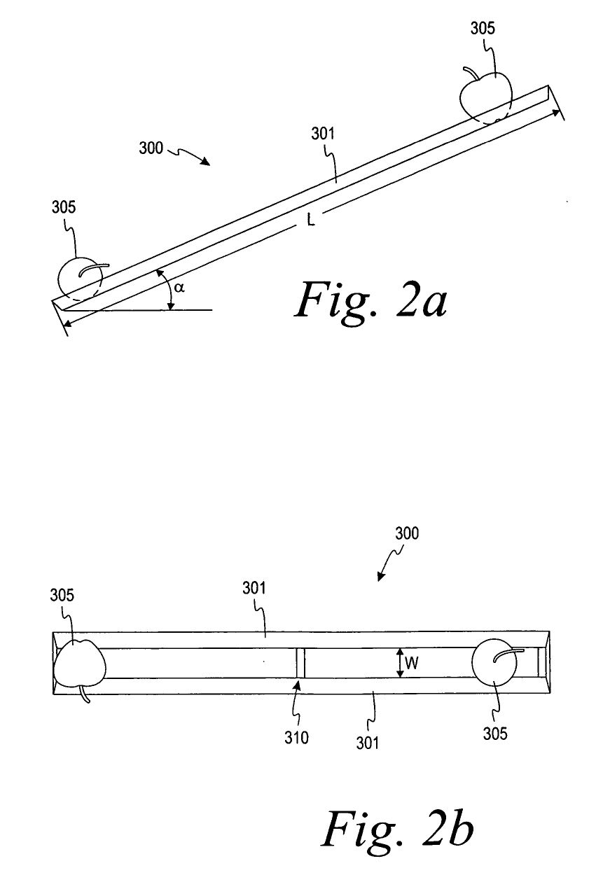

As shown in FIGS. 2(a)-(b), one apparatus in accord with the present concepts comprises a support 300 or track having two spaced apart support surfaces 301 having a length L and, in the illustrated example, a gap W therebetween. The support 300 and support surface(s) 301 may be straight, as shown in FIGS. 2(a)-(b), or may assume any other three-dimensional shape consistent with the concepts and objects disclosed herein including, for example, curvature along one or more axes and/or vertical displacement of one of the supports support surfaces 301 from another one of the supports over all or a portion of the support 300. In one aspect of the present concepts, the support 300 (and support surface(s) 301) could curve upwardly or downwardly over at least a portion of the support. For example, the support 300 could curve upwardly at or subsequent to a portion of the support wherein the object 305 has been reoriented in the proper position so as to gently decelerate the object subsequent to such reorientation. For example, such deceleration could be used to slow the objects' 305 linear and/or rotational velocity prior to the objects' entry into a successive processing step. The support 300 (and support surface(s) 301) could also or alternatively curve to the left or right before, during, or after the objects' transition to a substantially stable rotational state.

The support surfaces 301 may be parallel or may be non-parallel (e.g., diverging, converging, or both with a varying gap W), in-whole or in-part, so long as the gap W between the support surfaces does not exceed the minimum diameter of the object (e.g., apple) of random orientation to be rolled between the supports. Alternatively, gap W could be selected to permit only objects of a minimum size (e.g., large apples) to pass to the next processing step and to permit smaller objects to drop between the supports to another processing step. Thus, segregation of objects 305 by size, where necessary, may occur upstream of the support 300, or may optionally utilize the gap W, or a portion thereof to a similar end. In one example of the present concepts adapted to sorting, successive layers of supports 300 having varying sizes of gaps W between the support surfaces 301, such as in a designated sorting area thereof, with the supports having larger gaps being disposed on the upper layer and supports of successively smaller gaps being sequentially disposed therebeneath, may be used for such segregation.

The support 300 support surfaces 301 may comprise, for example, opposing rods, beams, member, linear or curvilinear surface, or taut member. In the case of opposing rods, beams, members, or the like, these structures may have any suitable cross-sectional shape including, but not limited to, square, rectangular, triangular round, ovoid, curved, quadrilateral, and/or polygonal shapes. The opposing support surfaces 301 may also be joined together to form a unitary support 300 having a single support surface 301, such support defining a trough, such as an angled or V-shaped trough; having an angle β defined between such opposing sides, or a U-shaped trough. In another example, such a unitary support 300 may also consist of a curved or a cylindrical half-pipe or pipe, or variations thereof (e.g., ¾-pipe), in which the rotatable object is disposed to roll. Any of the aforementioned configurations of support 300 and support surfaces 301 may be used singly or in combination with other support configurations. For example, the support surfaces 301 could start as a pair of opposing round rods, transition into an enclosed circular or non-circular pipe, and then be output into a V-shaped trough. In another example, a geometry of the opposing rods (e.g., 301) may vary in geometry over a length thereof, such as by a change in dimension (e.g., a change in a diameter of the rod(s)) or a change in shape (e.g., changing from a round to an ovoid shape).

The support 300 support surfaces 301 may advantageously comprise a semi-rigid or rigid material or materials such as, but not limited to, a metal, alloy, plastic, thermoplastic material, thermosetting material, polystyrene, polyethylene, polyurethane, polycarbonate, polyester, polypropylene, Kevlar, polyamide, resinous material, wood, fiber, textile, and composite, or combinations thereof. Support surfaces 301 could even comprise non-rigid members such as ropes or cables comprising, for example, fibers, textiles, metals, or alloys, drawn taut to provide a surface able to support the weight of the object 305 without displacement to a degree which would interfere with the objects and functions outlined herein.

In still other aspects, support surfaces 301 may comprise substantially resilient materials such as, but not limited to, elastomeric material, natural rubber, synthetic rubber, sponge rubber, and a flexible pressurized tubing affixed to an upper surface thereof or disposed thereon. The optional flexible pressurized tubing affixed to or disposed on support surfaces 301 may optionally comprise a plurality of holes or nozzles formed across an upper surface thereof to permit pressurized air to be output therefrom to form an air cushion upon which the object 305 may translate and rotate.

In the example shown in FIGS. 2(a)-(ba), the support 300 support surfaces 301 are configured to provide the object conveyed thereupon (e.g., an apple) with two points of contact as the object moves from an initial position I₁ at the top of the support 300 to a final position I₂ at the bottom of the supports. Support surfaces 301 are not required to be continuous and the present concepts do not require that the presently preferred two points of contact need be continuous or simultaneous at all times. In fact, experimentation using the apparatus of FIGS. 2(a)-(b) has shown that the tested apples will move to an orientation such that the apples spin along the stable spinning axis once the angular or rotational velocity of the object exceeds ωₘᵢₙ (Eq. (14)).

The inventors observed that, as the rolling apples reoriented themselves during travel (e.g., in the vicinity of the position where the apples reach a minimum critical value of rotational velocity), the apples at times skipped and lost contact with one or both rails one or more times before finally settling against the support surfaces 301 in a final stable rotational orientation in which the apples were spinning along their stable spinning axis. In other words, the inventors found that a stationary apple placed in a random orientation at the top of the support 300 will, during its descent to the bottom of the support, reorient itself so that the apple spins with the stem/calyx axis substantially perpendicular to the direction of travel. Although two points of contact between the object 305 and the support 300 are presented as a presently preferred example, it is not an absolute condition and a support 300 presenting additional contact points or surfaces, or a single contact point or surface, may be advantageously utilized.

In the illustrated example of FIG. 2(b), wherein the support 300 is supported only at the upper and lower ends, the support 300 is rigid enough (or stiff enough) so as not to substantially deform under the weight of the objects 305 (e.g., apples) conveyed thereupon. The support 300 opposing support surfaces 301 may optionally be connected to one another or to another object, such as a wall or a floor, at various points along the length thereof using one or more connecting members 310 inclusive of transverse members, lateral members, or vertical members, as appropriate. For example, in FIG. 2(b), the connecting member 310 comprises a single transverse member joining together the opposing support surfaces 301 to increase the overall rigidity or stiffness of the support 300. Vertical members could likewise be used to connect the support 300 to the floor or other subjacent rigid member and horizontal members could be used to connect the support 300 to a wall or other rigid adjacent member or object.

Support 300 support surfaces 301 may be optionally coated with or have a surface material applied thereto to change a surface property thereof, such as but not limited to a friction-altering surface, a wear surface, or an anti-bacterial surface.

The minimum length L of the support 300 is generally a function of the support inclination angle α. The inclination angle α provides, with the assistance of gravity, the basic conditions necessary to continually increase the object's 305 linear and angular or rotational velocity. With a sufficient support surface 301 length, the object 305 will eventually attain a sufficiently high rotational velocity to transition from an initially unstable rotation to a stable rotation. In the apparatus depicted in FIGS. 2(a)-(b), whereupon the rotation of an apple has been investigated, a support 300 having a support surface 301 length of about 10′ arranged at a substantially constant angle of between about 15°-30° with respect to the horizontal was found to successfully impart such preferred orientation for objects placed in a random orientation at the top of support 300.

There is no need or requirement for a constant inclination angle α and the inclination angle α may advantageously vary over the support 300 or support surface 301 length. In various aspects, the inclination angle α may generally decrease with increasing support 300 or support surface 301 length or may comprise a plurality of sections with a plurality of different angles with transitions therebetween. For example, for a support 300 having a unitary support surface (e.g., a U-shaped trough), a first support surface 301, into which an object is introduced, could have an inclination angle α of 12°, a second support surface having an inclination angle of 8°, and a third support surface having an inclination angle selected to decelerate the object 305. It is to be noted that the example of FIGS. 2(a)-(b) is a non-limiting example and the inclination angle α may be, for example, a steeper angle (e.g., 35°) or shallower angle (e.g., 5°-15°) than indicated above. The minimum angle of the support 300 would be that angle which is sufficient to keep the object rolling, and preferably that angle which would be sufficient to continuously rotationally accelerate the object (e.g., under the influence of gravity).

In the above example, the minimum critical angular velocity was obtained using an inclined support 300 having support surfaces 301. However, the present concepts are not limited to the above-noted example and other means of increasing the angular velocity to the aforementioned minimum critical value, as discussed by way of example below. For example, the support 300 support surfaces 301 could be replaced in whole or in part along a length thereof, by upwardly moving belts which increase the angular rotation of the downwardly moving object 305 when such upwardly moving belts contact the downwardly rolling object. In one aspect, such upwardly moving belt(s) could be provided only on an upper or initial portion of support 300 so as to rapidly increase the object's 305 initial rotational velocity to a point below or near the minimum critical angular velocity, while retaining the support 300 support surfaces depicted in FIGS. 2a-2b in the portion of the device wherein the transition between unstable and stable rotations is to occur.

In another aspect, the inclination angle α of support 300 support surfaces 301 could be zero or a small positive angle near zero (e.g., horizontal or substantially horizontal) and the primary mechanism for increasing the angular velocity to the aforementioned minimum critical value could comprise moving belts configured to impart torque to the selected object 305 (e.g., an apple). In this aspect, a restraint may be utilized to control or minimize the linear movement of the object 305 in the direction of movement of the belts. Such restraint could comprise a physical impediment to motion, such as a passive roller, a driven roller (preferably driven in the opposite direction of rotation of the object 305 to minimize retardation of the objects' angular velocity), bar, brush, or fingers. Alternately, the restraint could be an external force, such as gravity, wherein the supports and belts move upwardly, but are configured such that the object 305 spins substantially in place rather than traveling upwardly.

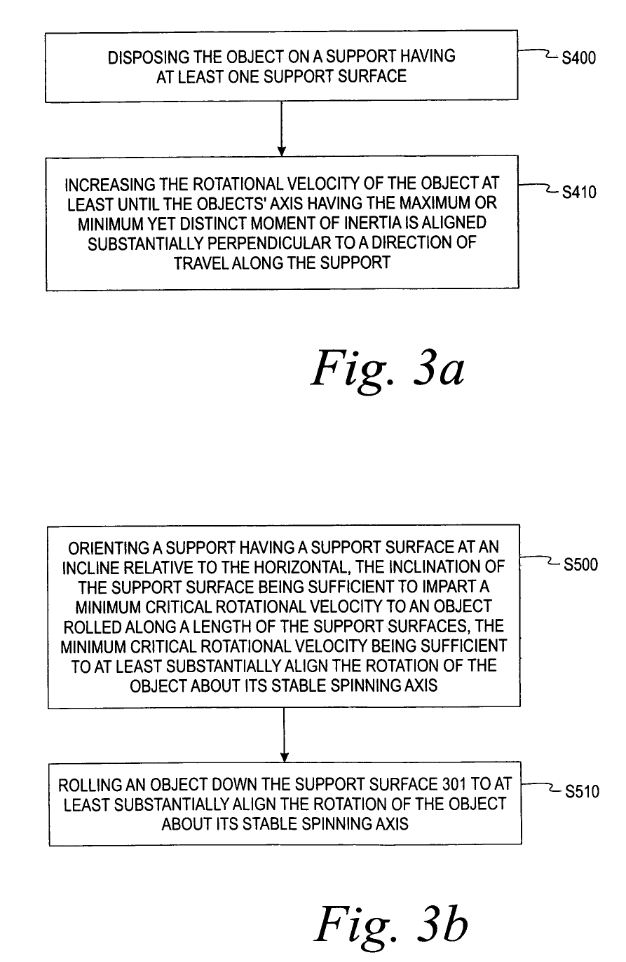

FIGS. 3(a)-(b) show acts in methods of orienting a rotatable object about its stable spinning axis in accord with the present concepts. In FIG. 3(a), a method for orienting an object about its stable spinning axis is shown to comprise the acts of disposing the object on a support 300 having at least one support surface 301 (S400) and increasing the rotational velocity of the object 305 at least until the objects' axis having the maximum or minimum yet distinct moment of inertia is aligned substantially perpendicular to a direction of travel along the support (S410). The act of increasing the rotational velocity of the object 305 may comprise rolling the object down and along the support 300 support surface(s) 301 under the influence of gravity. In another aspect of the method, the support 300 support surfaces 301 may comprise belts and the act of increasing the rotational velocity of the object may optionally comprise moving the belts in a common direction while substantially preventing translation of the object.

In another aspect of the present concepts, shown in FIG. 3(b), a method for orienting an object about its stable spinning axis is shown to comprise the act of orienting a support 300 having a support surface 301 at an incline relative to the horizontal, the inclination angle α of the support surface being sufficient to impart a minimum critical rotational velocity to an object 305 rolled along a length of the support surfaces, the minimum critical rotational velocity being sufficient to at least substantially align the rotation of the object about its stable spinning axis (S500). The method also includes the act of rolling an object down the support surface 301 to at least substantially align the rotation of the object about its stable spinning axis (S510).

In accord with the foregoing concepts, randomly oriented objects such as, but not limited to, apples and other fruits, may be rotated in a manner that places the objects' stable spinning axis (e.g., the stem/calyx axis) in a known orientation regardless of its initial orientation. This is accomplished by imparting a sufficient rotational or angular velocity to the object which exceeds ωₘᵢₙ (Eq. (14)), at which the object orients to rotate stably about its stable spinning axis. In the example of an apple, when the velocity of the apple reaches the point where the apple orientation is determined by the moment of inertia, the orientation of the apple will be such that the stem/calyx axis is parallel to the plane of the support 300 support surface(s) 301 and perpendicular to the direction of travel. The apple can therefore be uniformly positioned, in accord with the preceding concepts, for a subsequent processing step (e.g., inspection, movement, packaging, etc.).

Each of these embodiments and obvious variations thereof is contemplated as falling within the spirit and scope of the claimed invention, which is set forth in the following claims. For example, although the present concepts are illustrated by a single support 300, a plurality of supports (e.g., dozens, hundreds) could be implemented substantially adjacently and substantially in parallel to meet throughput needs of a particular site. In one aspect thereof, the input of objects onto adjacent supports 300 could be staggering so as to minimize interference of objects on such adjacent supports. In another aspect, the input of objects onto the supports could comprise introducing them onto the supports with a non-zero linear or rotational velocity.

Further, the appended claims reflect certain aspects and combinations of the present concepts, but are not exhaustive of all such aspects and combinations. For example, a containment or retaining structure could be incorporated into or adjacent the support to ensure that objects losing contact with the support due to dynamic instabilities occurring during the transition from an unstable dynamic state to a stable dynamic state are retained within the disclosed system. It is preferred, but not necessary, that the containment or retaining structure be adapted to guide the object back into engagement with the support. Further, the present concepts include all possible logical combinations of the claims and of the various claim elements appended hereto, without limitation., within the associated claim sets regardless of the presently indicated dependency.

1. An apparatus for orienting an object about its stable spinning axis comprising:
a support comprising a support surface, the support surface being inclined relative to the horizontal, the length and the inclination of the support surface being selected to, in combination, impart a minimum critical rotational velocity to an object rolled on the support surface, the minimum critical rotational velocity being sufficient to at least substantially align the rotation of the object about its stable spinning axis.

2. An apparatus for orienting an object about its stable spinning axis in accord with claim 1, wherein the support surface comprises at least two support surfaces, wherein the at least two support surfaces are laterally spaced apart by a gap, and wherein the minimun dimension of the object is greater than the gap between the support members.

3. An apparatus for orienting an object about its stable spinning axis in accord with claim 1, wherein the stable spinning axis is an axis having a distinct maximum moment of inertia.

4. An apparatus for orienting an object about its stable spinning axis in accord with claim 1, wherein the stable spinning axis is an axis having a distinct minimum moment of inertia.

5. An apparatus for orienting an object about its stable spinning axis in accord with claim 1, wherein the object is an apple, and wherein the axis having at least one of a distinct maximum or minimum moment of inertia value comprises the stem to calyx axis.

6. An apparatus for orienting an object about its stable spinning axis in accord with claim 1, wherein the support surface is defined by a member having a cross-sectional shape defining at least one of a curvilinear channel and an angular channel.

7. An apparatus for orienting an object about its stable spinning axis in accord with claim 2, wherein the support surfaces deviate from parallel over at least a portion of their length.

8. An apparatus for orienting an object about its stable spinning axis in accord with claim 1, wherein the support surface comprises a resilient material attached to at least a portion of an upper surface thereof.

9. An apparatus for orienting an object about its stable spinning axis in accord with claim 8, wherein the resilient material comprises at least one of an elastomeric material, natural rubber, synthetic rubber, sponge rubber, and a flexible pressurized tubing.

10. An apparatus for orienting an object about its stable spinning axis in accord with claim 1, wherein the inclination of the support surface relative to the horizontal varies over at least a portion of length of the support surfaces.

11. An apparatus for orienting an object about its stable spinning axis in accord with claim 2, wherein the inclination of the support surfaces relative to the horizontal varies over at least a portion of length of the support surfaces.

12. An apparatus for orienting an object about its stable spinning axis in accord with claim 2, wherein each of the support surfaces comprises at least one of a rod, beam, tube, curvilinear surface, substantially planar surface, and taut member.

13. An apparatus for orienting an object about its stable spinning axis in accord with claim 12, wherein each of the support surfaces comprises at least one of a metal, alloy, plastic, thermoplastic material, thermosetting material, polystyrene, polyethylene, polyurethane, polycarbonate, polyester, polypropylene, polyamide, resinous material, Kevlar, wood, fiber, textile, and composite.

14. An apparatus for orienting an object about its stable spinning axis in accord with claim 13, wherein each of the support surfaces is defined by a member having a cross-sectional shape which may be constant or variable along at least a portion of a length thereof, and wherein the cross-sectional shape thereof comprises at least one of a square, rectangular, triangular, round, ovoid, curved, quadrilateral, and polygonal shape over at least a portion of a length thereof.

15. An apparatus for orienting an object about its stable spinning axis in accord with claim 2, wherein the support surfaces are movable to permit adjustment of at least one of the angle thereof with respect to the horizontal, the gap therebetween, and a vertical displacement therebetween over at least a portion of the length thereof.

16. An apparatus for orienting an object about its stable spinning axis in accord with claim 2, further comprising:
a conveyer belt moving adjacent the support surfaces, the conveyer being disposed to tangentially contact and impart a torque to an object disposed between and supported by the support surfaces.

17. An apparatus for orienting an object about stable spinning axis comprising:
a support comprising spaced-apart support surfaces, each of the support surfaces comprising a belt movable in a first direction at a predetermined minimum velocity, the predetermined minimum velocity being selected to impart to an object placed thereupon a minimum critical rotational velocity sufficient to at least substantially align the rotation of the object about its stable spinning axis; and
a restraint to impede translation of the object in the first direction.

18. An apparatus for orienting an object about its stable spinning axis in accord with claim 17, wherein the restraint comprises a physical impediment.

19. An apparatus for orienting an object about its stable spinning axis in accord with claim 17, wherein the restraint comprises at least one of a passive roller, a driven roller, a bar, a brush, a probe, a mechanical sensor, or fingers.

20. An apparatus for orienting an object about its stable spinning axis in accord with claim 17, wherein the restraint comprises an upward inclination of the belt support surface sufficient to prevent the object being rotated on the belt support surface from being conveyed upwardly by the belts.

21. An apparatus for orienting an apple about its stable spinning axis comprising:
a support comprising at least one support surface, the support surface being inclined at an angle greater than the dynamic friction factor between the support surface and an apple to be conveyed thereupon over at least a portion thereof, the length of the support surface and the inclination of the support surface being selected to, in combination, impart a minimum critical rotational velocity to an apple rolled down the support surface, the minimum critical rotational velocity being sufficient to at least substantially align the rotation of the apple about its stable spinning axis.

22. An apparatus for orienting an apple about its stable spinning axis according to claim 21, wherein the support surface comprises a plurality of support surfaces spaced apart from one another by a gap, and wherein the support surfaces are movable to permit adjustment of at least one of the angle thereof with respect to the horizontal, the gap(s) therebetween, and vertical displacement(s) therebetween over at least a portion of the length thereof.

23. A method for orienting an object about its stable spinning axis comprising the acts of:
disposing the object on a support having at least one support surface; and
increasing the rotational velocity of the object at least until the objects' axis having the maximum or minimum yet distinct moment of inertia is aligned substantially perpendicular to a direction of travel along the support.

24. The method of claim 23, wherein the support comprises a plurality of opposing support surfaces inclined at an angle with respect to the horizontal, and wherein the act of increasing the rotational velocity of the object comprises rolling an object down and along the support surfaces under the influence of gravity.

25. A method for orienting an object about its stable spinning axis comprising the acts of:
orienting a support having a support surface at an incline relative to the horizontal, the inclination of the support surface being sufficient to impart a minimum critical rotational velocity to an object rolled along a length of the support surfaces, the minimum critical rotational velocity being sufficient to at least substantially align the rotation of the object about its stable spinning axis; and
rolling an object down the support surface to at least substantially align the rotation of the object about its stable spinning axis.

26. A method for orienting an object about its stable spinning axis in accord with claim 25, further comprising the acts of:
disposing a plurality of supports adjacent one another, and
rolling objects down the plurality of supports along said support surfaces to at least substantially align the rotation of each of the objects about its stable spinning axis.

27. A method for orienting an object about its stable spinning axis in accord with claim 26, further comprising the act of:
introducing the objects to the respective supports with at least one of an positive initial velocity and an initial rotational velocity.

29. A method for orienting an object about its stable spinning axis in accord with claim 28, further comprising the act of:
staggering an introduction of objects to adjacent ones of the plurality of supports so as to prevent interference between rolling objects on adjacent supports.
